(19) United States
(12) Patent Application Publication
(10) Pub. No.: US 2004/0205119 A1
(43) Pub. Date: Oct. 14, 2004

(54) Method and apparatus for capturing web page content development data

(76) Inventors: Mary C. Streble, Morrisville, NC (US); Andrei Malacinski, Apex, NC (US)

Correspondence Address: Stephen J. Weed, Esquire, Synnestvedt & Lechner LLP, 2600 Aramark Tower, 1101 Market Street, Philadelphia, PA, 19107-2950, US

(21) Appl. No.: 10/106,431

(22) Filed: Mar. 26, 2002

(51) Int. Cl. G06F 15/16

(52) U.S. Cl. 709/203; 715/513

(57) ABSTRACT

A method for capturing content development data. The method includes formatting content development data received from a Web server at a client for transmission to a tracker application. The captured content development data may be used to analyze the effectiveness of Websites.

### FIELD OF THE INVENTION

The present invention relates to the World Wide Web (Web) and, more particularly, to analyzing Website activity.

### BACKGROUND OF THE INVENTION

The World Wide Web (Web) is a growing medium for buying and selling goods. Many retailers maintain Websites to offer goods and services for sale over the Web. Currently, there is a great deal of interest in analyzing the effectiveness of these Websites.

Traditionally, Website effectiveness was analyzed solely by collecting clickstream data associated with Web pages retrieved from the Website. Clickstream data is information a Web browser transfers to a Web server that hosts the Website when requesting a Web page. This information may include the uniform resource locator (URL) associated with the requested Web page, the referral URL, and the Internet Protocol (IP) address of the requester.

Presently, Web pages are often dynamically created by a Web application residing on the Web server when they are requested by a user through a Web browser running on the user's computer. The Web application collects data, such as the user's user ID or membership status, for use in dynamically creating Web content (referred to herein as “content development data”). The content development data can be used to identify a particular user or group of users to dynamically create Web pages for display on the Web browser that are tailored to a particular user or group of users. For example, consider an airline Website. If the Web application determines a user is a member of the airline's frequent flyer program, the generated Web page will include information tailored to frequent flyer program members, such as promotional airfares. On the other hand, if the Web application determines the user is not a frequent flyer program member, the generated Web page will include information tailored to nonmembers, such as the benefits of joining the frequent flyer program. In this example, the data indicating whether the user is a member of the frequent flyer program is content development data.

To gauge the effectiveness of Websites having dynamic Web pages, it is desirable to track the content development data used to generate the Web pages in addition to the clickstream data. The content development data is desirable because it contains information about the users accessing the Website that the clickstream data does not contain, e.g., membership information. FIG. 1 depicts generally a common environment for tracking content development data. Typically, a Web application 100 running on a Web Server 102 gathers content development data 104 to generate dynamic Web page content in response to a request from a Web browser 106 running on a client 108. Content development data 104 identified for use in analyzing the Website is then transferred via the client 108 to an analysis server 110 where the content development data 104 is retrieved by a known tracker application 114. The content development data 104 may be transferred using either cookies or URL parameters as described below. The Web server 102, client 108, and analysis server 110 communicate over a network 112, e.g., the Internet.

In content development data tracking methods involving the use of cookies, the Web application 100 generates cookies containing content development data 104 that are passed to the client 108. Cookies are small files containing information that a Web server 102 passes to a client 108 for use at a later time. The Web application 100 will insert instructions into the dynamic Web page content instructing the client 108 to transfer to the analysis server 110 all of the cookies stored on the client 108 that are associated with the Web server 102, including cookies unrelated to the content development data 104 that were passed to the client 108 for other uses. The tracker application 114 at the analysis server 110 then analyzes the cookies in a well known manner to retrieve the content development data 104. For example, using the airline Website example discussed above, a Web application 100 will pass a cookie to the client 108 that contains content development data 104 identifying a user of the Web browser 106 as a frequent flyer program member. Dynamic Web page content generated at the airline Website will contain an instruction for execution by the Web browser 106 that causes the transfer of all cookies associated with the Web server 102, including the cookie identifying the user as a frequent flyer program member, to the analysis server 110 for retrieval of the content development data 104.

The use of cookies to track content development data 104, however, will not work if the user configures the Web browser 106 so that it will not accept cookies. In addition, each cookie has a limited storage size (e.g., 4 K bytes) and, thus, multiple cookies may be required for storing all the page development data. Additionally, there are a limited number of cookies that can be stored on a user's computer and, therefore, the amount of memory available for storing cookies may be insufficient to handle all of the content development data 104. Also, all of the cookies associated with a Web server 102 are transferred to the analysis server 110, thus potentially passing data other than the content development data 104 used to dynamically generate the Web page file. Accordingly, additional network 112 resources are required to transfer the cookies containing information unrelated to content development data along with the cookies containing content development data 104, and additional processing by the analysis server 110 is required to identify the cookies containing the content development data 104.

In content development data tracking methods involving the use of URL parameters, the content development data 104 and an URL associated with the tracker application 114 are formatted at the Web server 102 as a hyper text mark-up language (HTML) image request, thus requiring the Web server 102 to perform an additional formatting function. The HTML image request is a well known instruction that is executable by the Web browser 106 for retrieving content, typically an image file, identified in the request from a server such as the Web server 102 or analysis server 110. In the URL parameters method, the tracker application 114, rather than an image file, is identified in the request. When the image request is processed by the Web browser 106, the tracker application 114 is requested from the analysis server 110 and the content development data 104 is transferred to the analysis server 110 as part of the image request.

The tracker application 114 at the analysis server 110 is executed in response to the image request and then retrieves the content development data 104 contained in the image request. For example, the Web application may insert an image request into a Web page such as <img src=“http://www.youranalysissite.com/track?appData=xyz”>, where www.youranalysissite.com/track is an URL associated with the tracker application 114 at the analysis server 110 that will retrieve the content development data “xyz” from the image request. When the image request is executed by the Web browser 106, the Web browser 106 will send a request for the tracker application 114 to the analysis server 100. The tracker application 114 will run in response to the request and retrieve the content development data “xyz.” This use of URL parameters requires that the Web server 102 format the content development data and the URL of the tracker application 114 into an image request. Therefore, this method requires processing at the Web server 102 that could be devoted to other tasks.

Accordingly, there is a need for methods, systems, and products for tracking content development data that are not subject to the limitations described above. The present invention fulfills this need among others.

### SUMMARY OF THE INVENTION

The present invention provides a method, system, and product for capturing content development data that overcomes the aforementioned problems by formatting content development data received from a Web server at a client instead of at the Web server and, then, passing the formatted content development data from the client to a tracker application.

One aspect of the present invention is a method for capturing content development data from a server perspective. The method includes generating a data stream at a first server in response to a content request from a client, passing the data stream to the client (the content development data to be formatted at the client for transmission to a tracker application, and receiving the content development data at the tracker application for retrieval.

Another aspect of the present invention is a method for capturing content development data from a client perspective. The method includes receiving a data stream at a client from a first server in response to a content request from the client, the data stream including at least content development data, formatting the content development data for transmission to a tracker application, and passing the formatted content development data to the tracker application.

In addition, the present invention encompasses systems and computer program products for carrying out the inventive methods.

### BRIEF DESCRIPTION OF THE DRAWINGS

FIG. 1 is a block diagram of a typical environment for collecting content development data;

FIG. 2 is a block diagram of a typical environment for collecting content development data in which the present invention may be practiced.

FIG. 3 is a flow chart depicting steps for tracking content development data in accordance with the present invention;

FIG. 4A is an example HTML source code listing for a dynamically created Web page file for a frequent flyer program member;

FIG. 4B is an example HTML source code listing for a dynamically created Web page file for a non-frequent flyer program member; and

FIG. 5 is an example HTML source code listing for a dynamically created Web page file in accordance with the present invention.

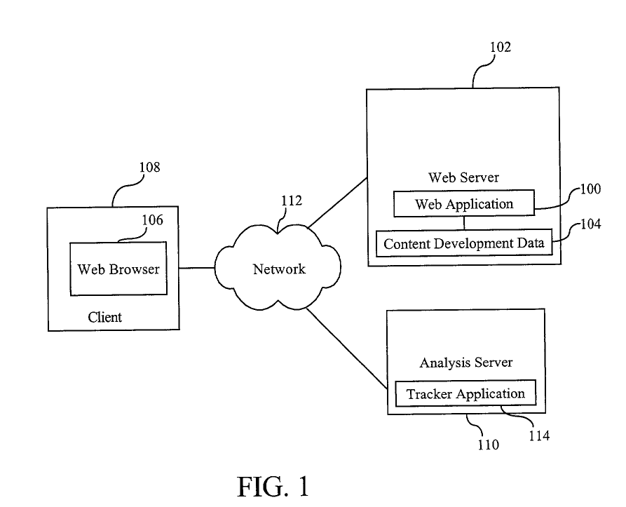

### DETAILED DESCRIPTION OF THE INVENTION

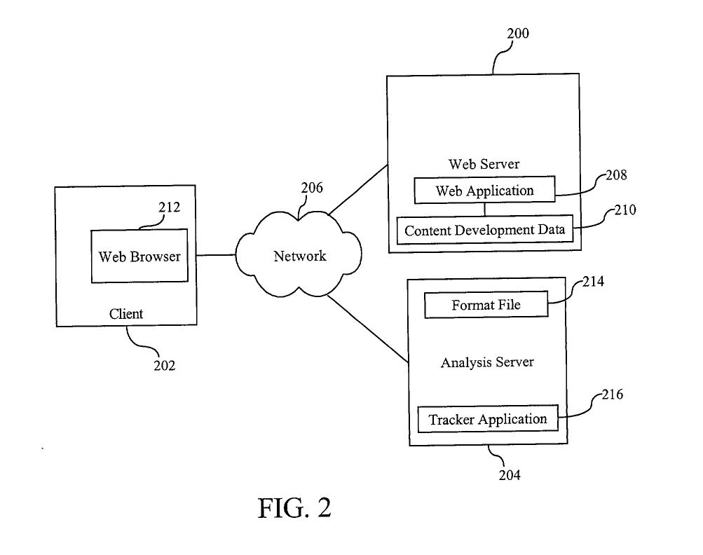

FIG. 2 depicts a typical environment in which the present invention may be practiced. The environment includes a Web server 200, a client 202, and an analysis server 204, all of which are capable of communicating over a network 206, e.g., the Internet. The Web server 200 is a conventional server computer on which a Web application 208 resides. The Web application 208 dynamically generates Web content requested by the client 202 based on data associated with the client 202 that is known to the Web application 208, i.e., content development data 210. The Web server 200 may be an HTTP server, an application server, or essentially any server for serving content to the client 202.

The client 202 is a client processing device for requesting and presenting content from the Web server 200. In addition, in accordance with the present invention, the client 202 performs the step of formatting content development data 210 received from the Web server 200 for transmission to a tracker application 216 at the analysis server 204. The client 202 may be essentially any processing device for presenting visual and/or audio content including, but not limited to, a desktop computer, laptop computer, handheld device, personal digital assistant (PDA), cellular telephone, etc. In a preferred embodiment, the client 202 is a conventional client computer that includes a conventional Web browser 212 for requesting and displaying Web pages from the Web server 200. Preferably, the Web browser 212 is JavaScript enabled, such as Microsoft's Internet Explorer 5.0 and Netscape 4.7 and 6.0. JavaScript is a well known programming language that utilizes instructions that can be performed by another program.

The analysis server 204 is a conventional server computer that receives content development data 210 from the Web server 200 via the client 202 over the network 206. In a preferred embodiment, the analysis server 204 includes a format file 214 that is passed to the client 202, when requested, for use in formatting the content development data 210 and a tracker application 216 for retrieving the content development data 210 as formatted by the client 202. It will be understood by those skilled in the art that the Web server 200 and the analysis server 204 may reside on a single server computer, on separate computers in the same location, or in geographically diverse locations.

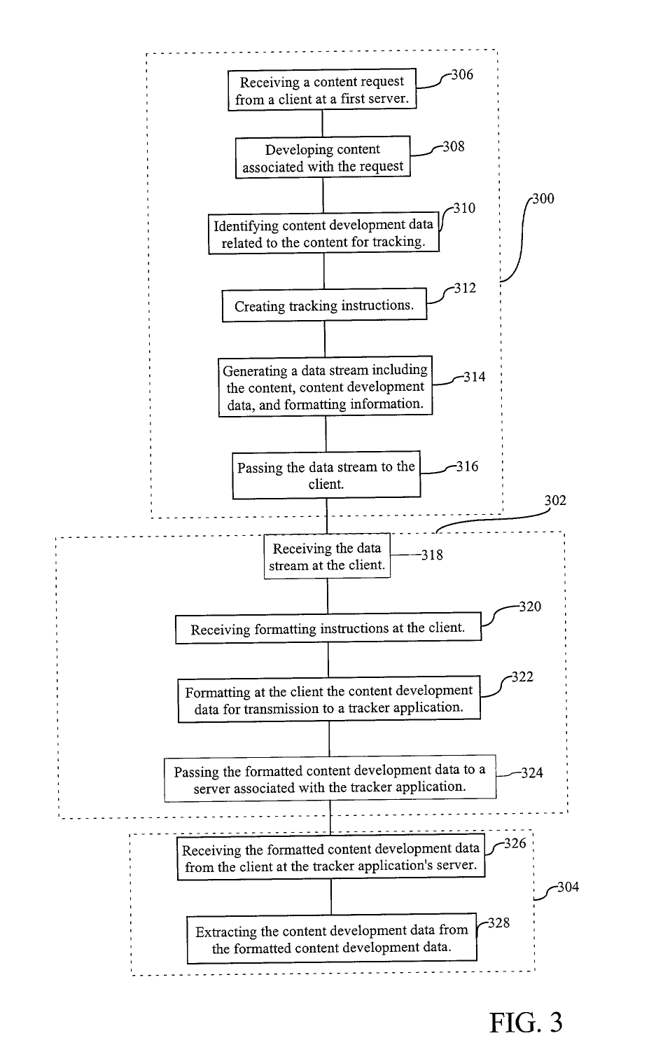

In a preferred use, the typical environment of FIG. 2 enables the novel method depicted in FIG. 3 to be performed. Referring to FIG. 3, the method of the present invention includes the general steps of generating a data stream including at least content development data at a Web server (at step 300), formatting the content development data at a client for transmission to a tracker application (at step 302), and retrieving the content development data at a server associated with the tracker application (at step 304).

The generation of a data stream of step 300 may be performed using steps 306 through 316 described below. At step 306, a first server, e.g., the Web server 200 (FIG. 2), receives a content request from a client. In a preferred embodiment, the content request is a request for a Web page displayable on a Web browser at the client. For example, the content request may be a request from the Web browser to a particular Web server for a Java Server Page (JSP) file.

In the preferred embodiment, the client initiates the content request using the Web browser and the request is routed over the network in a known manner for reception at the Web server. For example, a user of the Web browser can initiate the content request by inserting an URL associated with a particular file into an address field of the Web browser and pressing the “Enter key” on the user's keyboard. After the Enter key is pressed, the Web browser sends a request for the particular file from the Web server identified in the URL. Alternatively, the user can initiate the content request by selecting a “Web link” corresponding to an URL associated with a particular file, which results in the Web browser sending a request for the particular file. Additional alternative methods for initiating a content request will be apparent to those skilled in the art.

At step 308, the Web server develops content associated with the content request of step 306. In a preferred embodiment, the content is Web page content for display at a Web browser that is tailored (i.e., personalized) to a particular user or group of users. A Web application at the Web server dynamically creates the Web page content based on content development data available to the Web application. The content development data may include information such as the user's “user ID” that was used to access information on the Web server or other information that is related to the user. For example, on an airline Website, the content development data may be a designation that the user is a member of the airline's frequent flyer program. The content development data can be retrieved using known techniques such as through gathering user login information, fetching previously generated cookies, etc.

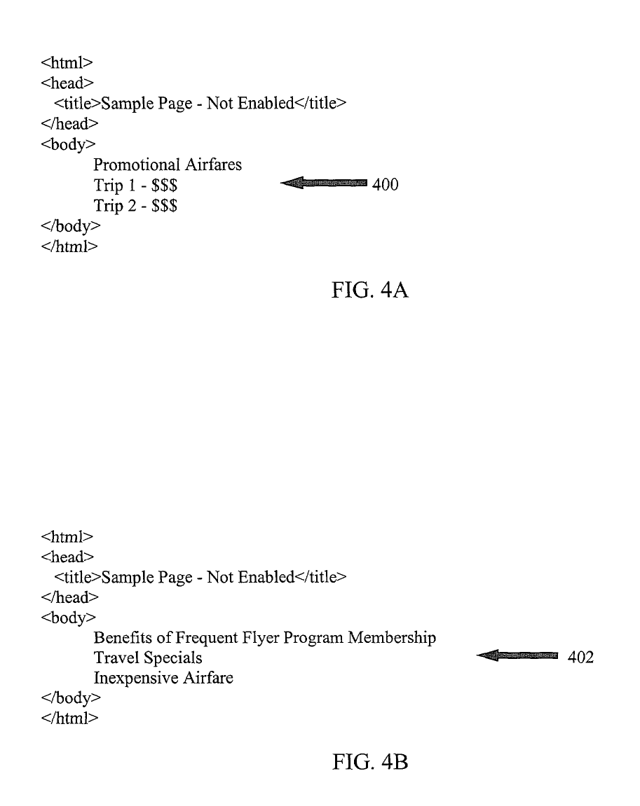

FIGS. 4A and 4B are illustrative examples of dynamic Web page content developed at step 308. In these examples, the content development data is an indicator identifying whether a user of a Web browser is a member of a frequent flyer program. If the Web application determines the user is a frequent flyer program member, the Web application creates the Web page content depicted in FIG. 4A, which includes promotional airfare information 400, for display on the Web browser. On the other hand, if the Web application determines the user is not a frequent flyer program member, the Web application creates the Web page content depicted in FIG. 4B, which includes frequent flyer membership benefit information 402, for display on the Web browser.

Referring back to FIG. 3, at step 310, content development data used to develop content in step 308 is identified for tracking at the Web server. In the preferred embodiment, the content development data for tracking is selected from the content development data the Web application used to dynamically create the Web page content in step 308. In certain embodiments, all content development data used to develop the Web page content will be identified for tracking. In certain other embodiments, only content development data selected by the entity that is analyzing the effectiveness of the Website will be identified for tracking. For example, if the content development data includes a user's user ID and an indicator of whether the user is a frequent flyer, the entity may select only the frequent flyer indicator for tracking to preserve the user's privacy. The content development data can be identified for tracking using techniques known to those skilled in the art.

At step 312, tracking instructions are created at the Web server. In a preferred embodiment, the tracking instructions contain a format file request instruction set. The format file request instruction set is a set of instructions for retrieving a format file. The format file contains one or more instructions to format the content development data and pass the content development data to the server. The tracking instructions created at the Web server also contain the identified content development data of step 310 and one or more invoking instructions to invoke the formatting instructions contained in the format file. The content development data is preferably passed as a parameter in one or more of the invoking instructions that invoke the formatting instructions. In an alternative embodiment, the tracking instructions include the formatting and invoking instructions for formatting the content development data and passing the content development data to the server, thus eliminating the need to request a separate format file. Preferably, the tracking instructions include JavaScript program instructions created by the Web application for inclusion in dynamically created Web page content.

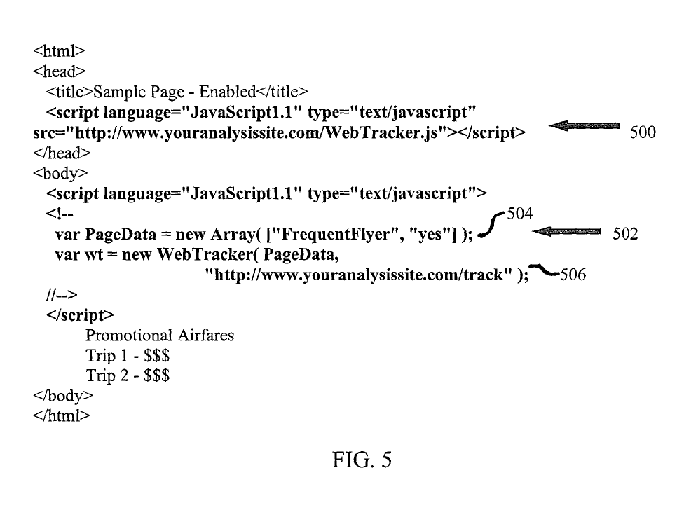

FIG. 5 illustratively depicts tracking instructions in accordance with the preferred embodiment described in step 312 for inclusion in Web page content, such as the Web page content depicted in FIG. 4A. The Web page content depicted in FIG. 5 is identical to the Web page content of FIG. 4A except that it includes a format file request instruction set (in bold) in a first script section 500 and invoking instructions in a second script section 502. The first script section 500 is added to the document header (i.e., information between the HTML angle bracket pairs <head> and </head>) and the second script section 502 is added to the document body (i.e., information between the HTML angle bracket pairs <body> and </body>).

The first script section 500 identifies the scripting language used (i.e., JavaScript 1.1), the source type (i.e., text/javascript), and the location of the format file (i.e., WebTracker.js). The source (src) attribute identifies the URL of the format file (i.e., http://www.youranalysissite.com/WebTracker.js). When executed on a JavaScript enabled Web browser, the first script section 500 will retrieve the format file to the client on which the Web browser is running. It should be noted that the format file identified in FIG. 5 is depicted as being located at the analysis server, however, it will be apparent to those skilled in the art that the format file may be located on essentially any server accessible to the client over the network.

The second script section 502, as in the first script section 500, identifies the scripting language used and the source type. In addition, the second script section 502 includes the content development data, the location of a tracker application (i.e., track) at the analysis server, and instructions for launching the formatting instructions contained in the format file identified in the first script section 500. A first instruction 504 includes the content development data and instructs the Web browser to store the content development data in a new array (i.e., PageData). In FIG. 5, the content development data is a single key-value pair. The key, i.e., FrequentFlyer, is an indicator for whether the user is a member of the frequent flyer program, and the value, in this particular instance, is “yes.” It will be readily apparent to those skilled in the art that the content development data may comprise a plurality of key-value pairs. A second instruction 506 instructs the Web browser to run the instructions contained in the format file. In addition, the second instruction 506 passes the content development data (in an array format) and the URL for the tracker application at the analysis server to the instructions contained in the format file.

Referring back to FIG. 3, at step 314, the Web server generates a data stream including the content developed in step 308, the content development data identified in step 310, and the tracking instructions created in step 312. For example, the data stream may be a data stream corresponding to the Web page content depicted in FIG. 5. As described above in step 312, the content development data identified in step 310 may be included in the tracking instructions. The data stream is generated in a well known manner for passage over the network to the client. At step 316, the Web server passes the data stream generated in step 314 to the client in a well known manner in response to the content request from the client in step 306.

The formatting of the content development data of step 302 can be performed at the client 202 (FIG. 2) using steps 318 through 324. At step 318, the client 202 receives the data stream generated in step 314 from the Web server over the network in a well known manner. At step 320, the client receives formatting instructions for formatting the content development data. In a preferred embodiment, the instructions to format the content development data and to pass the content development data to the server are included in the format file described in step 312, which is passed to the client in a known manner in response to the Web browser executing the format file request instruction set received at the client as part of the data stream of step 318. The format file includes formatting instructions necessary to format the content development data for passage from the client to the analysis server. Preferably, a JavaScript instruction, such as the instruction in the first section 500 (FIG. 5), is performed by the Web browser in order for the client to receive the format file, e.g., WebTracker.js, which is a JavaScript file. It will be apparent to those skilled in the art that if a copy of the format file has been received previously, the Web browser, depending on the Web browser's configuration, may not retrieve the format file on subsequent executions of the first script section 500 since the format file will already be available at the client for formatting the content development data. In an alternative embodiment, the formatting instructions are included in the formatting information as described in the alternative embodiment discussed in reference to step 312. In accordance with this embodiment, the formatting instructions are received at the client in the data stream in step 318.

At step 322, the client formats the content development data for transmission to a tracker application 216 (FIG. 2), and at step 324, the client passes the formatted content development data to a server associated with the tracker application. Preferably, the server associated with the tracker application is the analysis server. The content development data is formatted by the client using the formatting instructions received at the client in step 320. In a preferred embodiment, the formatting instructions format the content development data by including the content development data in a resource request, such as an HTML-type image request, e.g.:

<img
src=“http://www.youranalysissite.com/track?PageData=‘UserInterest=tennis,golf;FrequentFlyer=yes’”>

The HTML image request is identified by the HTML tag <img>. Within the image tag is a source (src) attribute that identifies the URL of a tracker application (e.g., track) at the analysis server for extracting the content development data from the image request. In addition, the src attribute contains the content development data that is to be passed to the analysis server, which is the data after the question mark (?) in the sample HTML image request. In a preferred embodiment, the content development data is contained within the src attribute as a character string of key-value pairs. If multiple key-value pairs are being tracked, they may be separated by semicolons and if multiple values are being tracked for a particular key, they may be separated by a comma. For example, if the content development data for tracking is the user's interests (“UserInterest”) and an indicator of whether the user is a frequent flyer program member (“FrequentFlyer”), the content development data (Page Data) may have the following form:

?PageData=‘UserInterest=tennis,golf;FrequentFlyer=yes’

In the preferred embodiment, the content development data passes from the client to the analysis server when the Web browser performs the image request generated in step 322, e.g., as a content data stream.

In the preferred embodiment, the image request's main function is to pass the content development data from the client to the analysis server as opposed to its conventional function of requesting an image for display on the Web browser. The image request includes a request for a tracker application at the analysis server, rather than for an actual image. By including the URL for the tracker application and the content development data in the src attribute of the image request, when the Web browser performs the image request, the content development data is passed along with the image request to the analysis server where the tracker application is located. As will be discussed below, the tracker application is then used to extract the content development data from the image request.

It will be appreciated by those skilled in the art that the Web browser will expect to receive an image from the analysis server in response to its image request. Accordingly, the tracker application contains known instructions for redirecting the image request such that an actual image is returned to the Web browser. In a preferred embodiment, the actual image is a single pixel image configured as a non-display image. A single pixel is used since it can pass over the Web as a very small data stream and need not be displayed on the Web browser, but will satisfy the Web browser's expectation that an image be received in response to the image request. Accordingly, network traffic is minimized and the process is transparent to the user of the Web browser.

In addition, it will be appreciated by those skilled in the art that the content development data can be transmitted to the analysis server by using other commands. For example, the client can “POST” the content development data to the analysis server.

The retrieval of content development data of step 304 can be performed as described below. At step 326, the content development data formatted in step 322 at the client is received at the server associated with the tracker application, e.g., the analysis server 204 (FIG. 2). In a preferred embodiment, the content development data is transferred from the client to the analysis server as described above with reference to step 324.

At step 328, the content development data is extracted from the formatted content development data received in step 326. In the preferred embodiment, the content development data is extracted from the image request by the tracker application at the analysis server. The tracker application is launched when the image request identifying the tracker application is received at the analysis server. The tracker application then extracts the content development data from the image request by scanning the image request in a known manner for a distinct feature associated with the content development data. In the preferred embodiment, the distinct feature is a question mark (?) and an identifier such as “PageData” in the present example. Accordingly, the tracker application will analyze the data following the question mark to extract the content development data. The creation of a tracker application to extract the content development data will be readily apparent to those skilled in the art of computer programming.

The steps depicted in FIG. 3 may be implemented in a system including means for performing the novel steps. In addition, one or more of the novel steps may be implemented as computer program code executing on a computer. The computer program code may be embodied in a computer readable medium to form a computer program product.

Having thus described a few particular embodiments of the invention, various alterations, modifications, and improvements will readily occur to those skilled in the art. For example, although the description of the present invention relates to capturing content development data used to generate dynamic Web page content for viewing on a Web browser, the present invention may be used to capture content development data used to generate other types of content such as audio content associated with a cellular telephone. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for capturing content development data, said method comprising the steps of:
generating a data stream at a first server in response to a content request from a client, said data stream including at least content development data; and
passing said data stream to said client, said content development data being formatted for transmission to a tracker application at a location other than said first server.

2. The method of claim 1, wherein said location other than said first server is said client.

3. The method of claim 1, further comprising the steps of:
receiving said formatted content development data at said tracker application; and
extracting said content development data from said formatted content development data with said tracker application.

4. The method of claim 3, wherein said tracker application is located at said first server.

5. The method of claim 3, wherein said tracker application is located at a second server.

6. The method of claim 3, said data stream further including formatting instructions to format said content development data.

7. The method of claim 3, further comprising the step of passing a format file to said client, said client using said format file to format said content development data.

8. The method of claim 7, wherein:
said data stream further includes at least a format file request instruction; and
said format file is passed to said client in response to said format file request instruction being performed at said client.

9. The method of claim 1, wherein said generating step comprises at least the steps of:
developing content associated with said content request;
identifying said content development data; and
creating at least one tracking instruction.

10. The method of claim 9, wherein said at least one tracking instruction comprises at least:
a format file request instruction for requesting a format file; and
an invoking instruction for passing said content development data to instructions in said format file and executing instructions in said format file to format said content development data and to transmit said content development data to said tracker application.

11. The method of claim 10, further comprising the step of passing said format file to said client in response to said format file request instruction being performed at said client.

12. The method of claim 9, wherein said at least one format instruction comprises at least:
said content development data; and
instructions for formatting said content development data and transmitting said content development data to said tracker application.

13. The method of claim 3, wherein:
said receiving step comprises at least:
receiving a content data stream from said client at said tracker application's server, said content data stream including said content development data, said content data stream created when said content development data is formatted at said client; and
said extracting step comprises at least:
extracting said content development data from said content data stream.

14. The method of claim 13, wherein said content data stream is a resource request.

15. The method of claim 14, wherein said resource request is an image request.

16. The method of claim 14, wherein said resource request is a file request.

17. A method for capturing content development data, said method comprising the steps of:
receiving a data stream at a client from a first server in response to a content request from said client, said data stream including at least content development data;
formatting said content development data at said client for transmission to a tracker application; and
passing said formatted content development data to said tracker application.

18. The method of claim 17, wherein said tracker application is located at said first server.

19. The method of claim 17, wherein said tracker application is located at a second server.

20. The method of claim 17, further comprising the step of:
receiving formatting instructions at said client for use in said formatting step.

21. The method of claim 17, wherein said passing step comprises at least:
passing a file request from said client to said tracker application's server, said file request including said content development data, said file request created during said formatting step.

22. The method of claim 17, wherein said file request is an image request.

23. A system for capturing content development data, said system comprising:
means for generating a data stream at a first server in response to a content request from a client, said data stream including at least content development data;
means for passing said data stream to said client, said content development data being formatted for transmission to a tracker application at a location other than said first server;
means for receiving said formatted content development data at said tracker application; and
means for extracting said content development data from said formatted content development data with said tracker application.

24. The system of claim 23, wherein said location other than said first server is said client.

25. The system of claim 23, wherein said means for generating step comprises at least:
means for developing content associated with said content request;
means for identifying said content development data; and
means for creating at least one tracking instruction for requesting a format file, passing said content development data to instructions in said format file, and executing said instructions in said format file to format said content development data and to transmit said content development data to said tracker application.

26. A system for capturing content development data, said system comprising:
means for receiving a data stream at a client from a first server in response to a content request from said client, said data stream including at least content development data;
means for formatting said content development data at said client for transmission to a tracker application; and
means for passing said formatted content development data to said tracker application.

27. A computer program product for capturing content development data, said computer program product comprising:
computer readable program code embodied in a computer readable medium, the computer readable program code comprising at least:
computer readable program code for generating a data stream at a first server in response to a content request from a client, said data stream including at least content development data;
computer readable program code for passing said data stream to said client, said content development data being formatted for transmission to a tracker application at a location other than said first server;
computer readable program code for receiving said formatted content development data at said tracker application; and
computer readable program code for extracting said content development data from said formatted content development data with said tracker application.

28. The product of claim 27, wherein said location other than said first server is said client.

29. The product of claim 27, wherein said computer readable program code for generating comprises at least:
computer readable program code for developing content associated with said content request;
computer readable program code for identifying said content development data; and
computer readable program code for creating at least one tracking instruction for requesting a format file, passing said content development data to instructions in said format file, and executing said instructions in said format file to format said content development data and to transmit said content development data to said tracker application.

30. A computer program product for capturing content development data, said computer program product comprising:
computer readable program code embodied in a computer readable medium, the computer readable program code comprising at least:
computer readable program code for receiving a data stream at a client from a first server in response to a content request from said client, said data stream including at least content development data;
computer readable program code for formatting said content development data at said client for transmission to a tracker application; and
computer readable program code for passing said formatted content development data to said tracker application.
